(19) United States
(12) Patent Application Publication
(10) Pub. No.: US 2018/0020167 A1
(43) Pub. Date: Jan. 18, 2018

(54) Multi Background Image Capturing Video System

(71) Applicant: Production Resource Group, LLC, New Windsor, NY (US)

(72) Inventor: Daniel Hammond, San Fernando, CA (US)

(21) Appl. No.: 15/591,791

(22) Filed: May 10, 2017

Related U.S. Application Data
(60) Provisional application No. 62/334,324, filed on May 10, 2016.

(51) Int. Cl. H04N 5/272; H04N 5/265; H04N 5/262; H04N 9/75; H04N 5/04

(52) U.S. Cl. CPC H04N 5/272; H04N 9/75; H04N 5/04; H04N 5/2621; H04N 5/265

(57) ABSTRACT

A system which interleaves two or more backgrounds to create two or more different versions of a video, with different backgrounds. One of the videos has an image background, and another of the videos has a chromakey background. The system can separate the two versions of the video which have two different backgrounds.

This application claims priority from provisional application No. 62/334,324, filed May 10, 2016, the entire contents of which are herewith incorporated by reference.

### BACKGROUND

Chromakey systems operate by obtaining a video of objects and/or persons, referred to as the subject, in front of a chromakey color background. That chromakey color background is changed to some other simulated background. The viewer of the video sees the subject overlaid over the simulated background. The chromakey subject is thus shown on a different background, as desired, by changing the chromakey background into some desired image or video using the image processing equipment. The people and objects can then be formed as virtual settings in the resulting video. Chromakey operations have limitations. The object cannot be formed of certain colors which might interfere with the chromakey operation. For example, when a green screen is used as the chromakey background color, the subject should not have any green in it, and cannot have certain other colors in it that would interfere with the green. If the subject had green, then the viewer would see the background in place of the parts of the subject that were green.

### SUMMARY

The present application describes a multiple image capture video system.

Embodiments as described herein describe the camera that obtains a video that is separated by an image processor. Adjacent in time frames of the video have different backgrounds. In one embodiment, there are two backgrounds, one for chromakey, and one for an actual background, e.g. a background formed of an image. The video was taken twice as fast as desired, so that there are two backgrounds for each real desired frame of the video. Then, the image processing system separates the two frames, so that a first video is obtained that has a chromakey background, and a second video is obtained that has an actual background. Both the videos have the same objects in them, and are in essence the same video, but with different backgrounds.

### BRIEF DESCRIPTION OF THE DRAWINGS

In the Drawings:

FIG. 1 shows a block diagram of the system for creating an improved chromakey video; and

FIG. 2 shows an interleaved image sequence.

### DETAILED DESCRIPTION

Digital technology enables an LED video display screen or other digital projection source to be used to actually display the background, as an alternative to the chromakey screen that is used behind the subject of a chromakey video. The LED screen is used to display the actual background which is desired to be seen behind the object, where the actual background is typically an image or video (series of images) displayed behind the objects. An advantage of this system is that the background emits illumination onto the subject, which makes the subject's lighting look more natural. Also, there would be no limitations on the color(s) that could be included in the subject, as there typically is with chromakey systems, which typically prevent the subject from wearing green or blue clothing or items.

However, the inventors also recognize that the chromakey system includes certain advantages. Among those advantages is that when a chromakey system is used, the video creator can freely make changes to the background at any later time. Also, there can be pixelation and other effects from displaying the background on an LED screen. The image processing device that is used as part of the chromakey system can substitute any desired resolution of image or video for the background. Also, the chromakey system enables the video producer to change aspects of the background as desired.

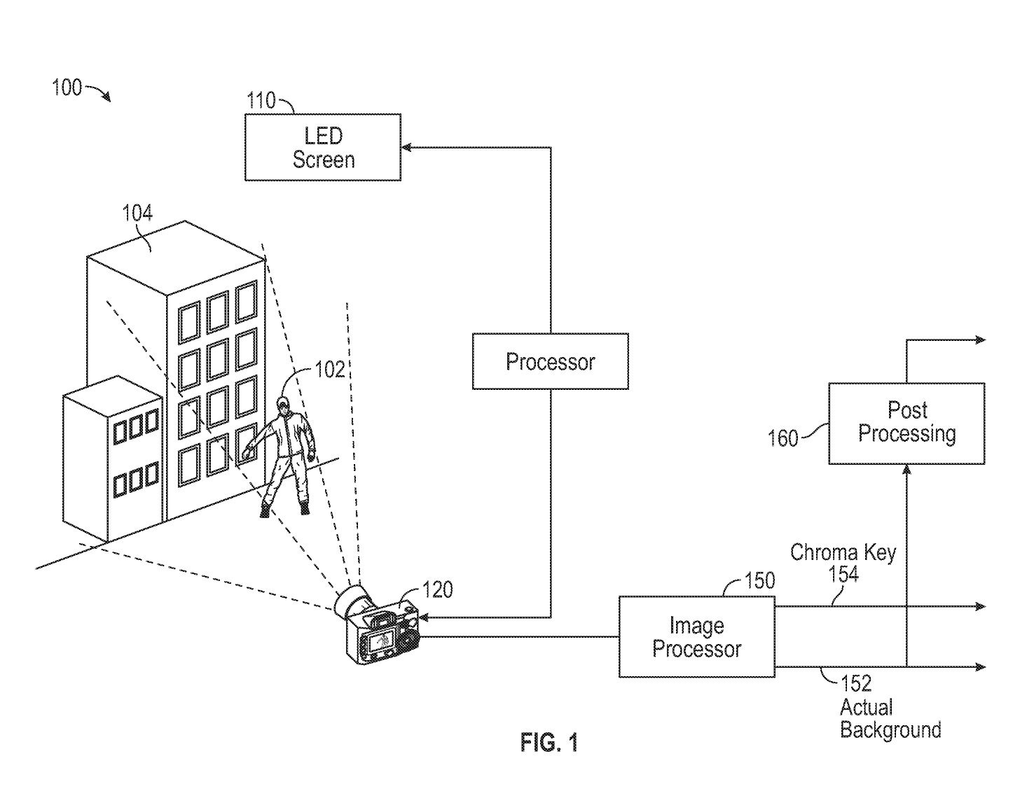

The present invention describes technology to address these issues. The overall system is shown in FIG. 1. The subject 100, which can include a person 102 and one or more objects 104 is placed in front of a screen 110 e.g. an LED video display array, which is controlled to display different backgrounds at different times.

A camera 120 records a video. The video is formed of individual frames that include the subject 100 in front of the screen 110, which may be an LED screen. A processing element 140 operates as described herein, to synchronize the camera 120 to take frames that are synchronized with the display on the screen of the alternating backgrounds.

According to an embodiment, the camera takes more images than are necessary in order to create the final video. In embodiments, the camera takes n frames, where n is 2 or greater, for each desired frame of the final video. One of the frames has an actual background, which in an embodiment may illuminate the objects. Another frame, which is adjacent in time to the first frame, has a chromakey background. The a chromakey background can be any of the chromakey frames as described herein. Where n is 2, there is typically one chromakey frame and one actual background frame. Where n is 3, there may be two chromakey frames of different colors or formats, and one background frame, or two different background frames having different scenes, and one chromakey frame.

In one simplified embodiment, the camera may take double the images which are necessary to obtain the video. In one embodiment, for example, a 24 frame per second video is desired. In this embodiment, 30 frames per second are actually taken, with each being 1/48 of a second receiving the chromakey backgrounded frame, and 1/48 of a second frames receiving ambient light from the actual image of the desired background image or scene on the video screen.

Alternate frames include different backgrounds on the screen 110, which are later separated by the image processor 150. This produces two videos, where both have the same “content”, i.e., the same objects in the same locations at the same times, but different backgrounds.

In this first embodiment, a first frame can be a chromakey background such as a green screen. During that first frame, the camera 120 is triggered at a time when the green screen is displayed in the background. This obtains frame number 0 in chromakey background.

A short time later, e.g. 1/24th of a second later, the screen 110 is controlled to display an desired background, for example the background of either the actual scene which is intended, or something approximating the actual screen which is intended. While the actual background is being displayed, the second frame is obtained, that frame being frame number 1 again, but this time with the desired background.

An image processing module 150 separates out the alternate frames into chromakey frames 151 and actual background frames 152.

In this way, from a single video acquisition, the video acquirer gets the opportunity to receive either a chromakey sequence of frames, or an desired/ actual background sequence of frames, or parts of both.

More complex operations can also be carried out using this system.

In one embodiment, the image from the actual background frames actually have more realistic lighting on the subject then the image from the chromakey frames. In this embodiment, the image processor 160 can be used for substituting the subject image from the actual background frames into the chromakey frames, so that the lighting of the subject in the chromakey frames is more natural looking by virtue of its being lit from the intended background “alternating” frames displayed from the screen 110.

The image capture device 120 can be any kind of camera, e.g. a film camera or a digital cinema camera or any other kind of camera. The camera is synchronized via a camera shutter pulse with the projection of light from the video display array 110. The camera is preferably a global shutter style camera, although a rolling shutter can be used also.

Imagers that use a global shutter operate by resetting the entire imager before each frame is taken. Each frame is comprised of multiple different pixels, each pixel being a sensor well in the imager device that integrates charge received via its photoreceptors. Before integration of any frame, the entire imager is reset to remove any residual signal in the sensor wells. The wells or pixels then integrate while exposed to the image frame, to accumulate charge for some period of time. In a global shutter of this type, the light collection for frame starts and ends at exactly the same time for all pixels. At the end of the time during which light is collected, or “integration period”, all charges are simultaneously transferred to light shielded areas of the sensor. The light shield prevents further accumulation of charge during the readout process. The charge is then shifted out of the light shielded areas of the sensor and read out, as the output of the camera.

This means that with a global shutter sensor, the scene is “frozen” in time with no motion blur. A preferred embodiment uses a digital imager with a global shutter, so that all pixels of the frame are acquired at the same moment.

Another embodiment, however, can use this system with a rolling shutter. With the rolling shutter, the photodiodes (pixels) do not collect light at the same time. All the pixels in one row of the imager collect light during exactly the same period of time, but the time that light collection starts and ends is slightly different for each row. The top row of the imager is the first one to start collecting the light and is the first one to finish collecting. The start and end of the light collection for each following row is slightly delayed. The total light collection time for each row is exactly the same, and the delay between rows in the rolling shutter sensor is constant. This means that with a rolling shutter sensor, the scene can have blur effects from motion. A rolling shutter sensor can still be used with this system, by syncing the background image/chromakey on the display screen 110 for the amount of time that the rolling shutter needs to “roll” from one end to the other, or by rolling the background image on the frame in sync with rolling of the shutter.

In one embodiment, the interleaved image sequence can be interleaved between an actual background, and a single color chromakey.

In another embodiment, the interleaved image sequence can be interleaved between the actual background, and multiple different color chromakeys. For example in this embodiment, the camera 120 can take four times as many images as are necessary for the actual video, e.g. 60 or 120 images per second. The first image may be actual background, while the second image is blue chromakey, the third image is green chromakey, and the fourth image is red chromakey. This may allow the video producer to have the maximum amount of flexibility, since they can use actual/desired background and/or any of multiple different chromakey colors, for each of the frames. When different objects with different colors are present in the different frames, different chromakey backgrounds can be selected.

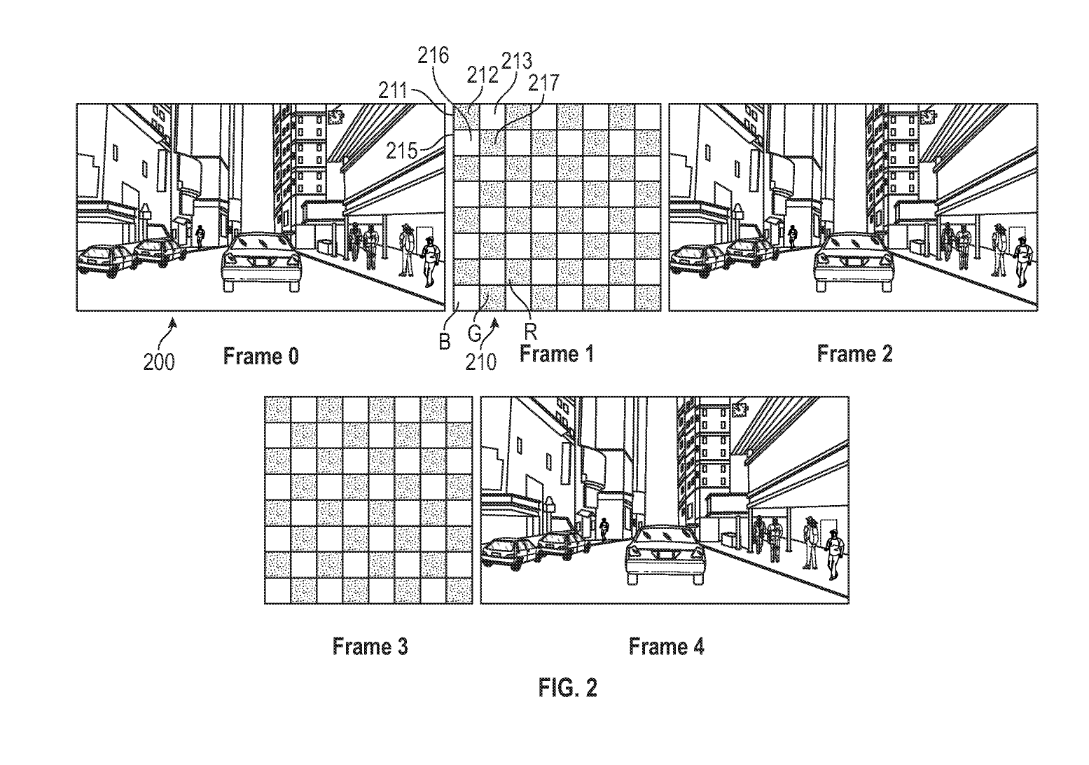

Another embodiment can use the alternating frame system of the first embodiment, along with the special chromakey frame shown in FIG. 2. In this embodiment, frame 0 is shown as the actual background image. Frame 1 is shown as the first chromakey background image. In this image, a background of alternating chromakey colors is used. The chromakey colors in the embodiment, are an array of 5×9 color areas, where each two adjoining colors are different. The top row alternates between blue areas 201 and green areas 202. The next row down 215 alternates between green areas 202, and red areas 203. The third row down is the same as the first row down, and all of the rows are arranged such that no two areas have the same no two adjoining areas have the same color. In this way, chromakey operations become possible with the different colors of chromakey all in one image.

In one embodiment, the special frame of FIG. 2 is used as one frame of a multiple frame image of intended background, fixed chromakey background and multiple color chromakey background.

Other embodiments are intended to be encompassed within the invention. Moreover, the invention is intended to include additional features such as processors, memory, and software.

What is claimed is:

1. A system of obtaining a video, comprising
an image processing system, obtaining a video formed of multiple frames of information, said frames including objects in front of a background,
Said video having groups of n frames, where n is 2 or greater, where each group of frames includes adjacent-in-time frames which have different backgrounds,
with a first frame of the group including a first background behind first objects, and a second frame of the group including a second background different than the first background behind said first objects at a time directly adjacent to a time of the first frame.

2. The system as in claim 1, wherein said first background is an image of a scene, and the background of the scene illuminates the first objects, and said second background is a background with at least one chromakey color.

3. The system as in claim 2, wherein said second background is a single color background.

4. The system as in claim 2, wherein said second background is multiple color background, including multiple different chromakey colors arranged in a grid, with each adjoining two items of the grid having different colors adjoining one another at all boundaries with the other colors.

5. The system as in claim 2, further comprising an image processor, receiving said video, and separating said video into a first chromakey background video and a second image background video.

6. The system as in claim 1, further comprising a camera, obtaining said video, a background screen, that displays an image as a background for said video, and a processor that synchronizes the obtaining of the video with different displays on the background screen.

7. The system as in claim 1, where said image processing system receives 48 frames per second, and produces a first 24 frames per second video with the first background, and a second 24 frames per second video with the second background.

8. A video obtaining system comprising:
a camera, which is synchronized by an input signal to obtain at least first and second different versions of each frame a of a desired video, said camera obtaining said frames at a speed greater than a speed of a final desired video,
said two different frames including at least a first frame that includes a chromakey background and a second frame that includes an image background; and
a processor, that produces said input signal to synchronize the camera to obtain the first version of the frame at a first time, and to also produces an output signal to a background screen to produce the chromakey background at the first time, and to synchronize the camera to produce the second version of the frame at a second time, adjacent in time to the first time, and also to produce an output signal to the background screen to produce an actual background at said second time.

9. The system as in claim 8, wherein said background screen is an LED screen.

10. The system as in claim 8, further comprising an image processor, that separates a plurality of first frames from a plurality of second frames to produce first and second different videos of the same action occurring, where the first and second videos have different backgrounds.

11. The system as in claim 8, wherein the chromakey background is a single color frame.

12. The system as in claim 8, wherein the chromakey background is multiple different colored chromakey colors arranged in a grid, with each adjoining two colors of the grid having different colors adjoining one another at all boundaries with all other colors.

13. A method of obtaining multiple videos of the same scene having different backgrounds, comprising:
obtaining a video formed of multiple frames of information,
said frames including objects in front of a background,
obtaining said video as multiple frame groups of n frames, where n is 2 or greater, where each frame group includes n adjacent-in-time frames, and each of said n adjacent in time frames have different backgrounds,
with a first frame of the frame group including a first background behind first objects, and a second frame of the frame group including a second background different than the first background behind said first objects at a time directly adjacent to a time of the first frame.

14. The method as in claim 13, wherein said first background is an image of a scene, and the background of the scene illuminates the first objects, and said second background is a background with at least one chromakey color.

15. The method as in claim 14, wherein said second background is a single color background.

16. The method as in claim 14, wherein said second background is multiple color background, including multiple different chromakey colors arranged in a grid, with each adjoining two items of the grid having different colors adjoining one another at all boundaries with the other colors.

17. The method as in claim 14, further comprising using an image processor for separating said video into a first chromakey background video and a second image background video.

18. The method as in claim 13, further comprising using a camera for obtaining said video,
Using a background screen to display an image as a background for said video, and using a processor to synchronize the obtaining of the video with different displays on the background screen.

19. The method as in claim 17, where said image processor receives 48 frames per second, and produces a first 24 frames per second video with the first background, and a second 24 frame per second video with the second background.
